(19) United States
(12) Patent Application Publication
(10) Pub. No.: US 2024/0229782 A1
(43) Pub. Date: Jul. 11, 2024

(54) ON-DEMAND ELECTRIC MOTOR CONTROLLED HYDRAULIC SYSTEM

(71) Applicant: Caterpillar Paving Products Inc., Brooklyn Park, MN (US)

(72) Inventor: Ryan James Nelson, Maple Grove, MN (US)

(73) Assignee: Caterpillar Paving Products Inc., Brooklyn Park, MN (US)

(21) Appl. No.: 18/095,758

(22) Filed: Jan. 11, 2023

(51) Int. Cl. F04B 1/324; F04B 49/06; F15B 15/18

(52) U.S. Cl. CPC F04B 1/324; F04B 49/06; F15B 15/18

(57) ABSTRACT

An on-demand electric motor controlled hydraulic system including a hydraulic pump, an electric motor coupled to the hydraulic pump, and an electronic control module (ECM) coupled to the hydraulic pump and the electric motor, is provided. The hydraulic pump has a swashplate with a swashplate angle adjustable to adjust a flow rate of the hydraulic pump and the electric motor is operable at a motor rate to drive the hydraulic pump. The ECM is configured to receive a demand for operating the hydraulic pump, determine a flow demand of the hydraulic pump associated with the demand, set the swashplate angle of a swashplate of the hydraulic pump to an initial swashplate angle, the initial swashplate angle setting a flow rate of the hydraulic pump corresponding to the flow demand, and operate the electric motor at a motor rate, the motor rate corresponding to the flow demand.

### TECHNICAL FIELD

The present disclosure relates to a system and method for operating an electric motor, and more particularly, to a system and method for controlling an electric motor driving hydraulic pumps based on demand.

### BACKGROUND

Machines may be used to perform a variety of tasks at a worksite. For example, machines may be used to excavate, move, shape, contour, and/or remove material present at the worksite, such as gravel, concrete, asphalt, soil, and/or other materials. For example, a machine may be equipped with a work implement for performing tasks, such as drilling, digging, carrying, raising, and/or depositing material. The work implement may include augers, brushcutters, brooms, grapples, hammers, pulverizers, rippers, rotors, shovels, and so forth. To operate these implements, the machine includes one or more hydraulics pumps driven by a prime mover of the machine, such as an internal combustion engine (ICE) including a diesel engine. However, during the work cycle, the engine is kept running, and the hydraulic pumps are always turning, which creates parasitic loads on the engine and decreases energy efficiency of the machine. Further, running the hydraulic pumps based on typical speeds of today's diesel engines results in less than optimal energy efficiency.

U.S. Pat. No. 10,822,722 by Wright (“the '722 patent”), issued Nov. 3, 2020, describes hydraulic systems comprising variable speed drives, such as electric motors, coupled to hydraulic pumps and methods of operating such systems. The drive speed of the electric motor is controlled based on the position of a hydraulic servo-control valve in order to reduce the flow through a bypass line. The valve position is determined based on the pressure-drive speed response of the hydraulic system, where an input of the pressure-drive speed response is provided by a pressure sensor measuring pressure in a hydraulic actuator or in an actuator line. Although the '722 patent describes increasing the overall efficiency of the hydraulic system by decreasing the drive speed of the electric motor as the valve is opening and sending a greater portion of the hydraulic fluid into the bypass line, the flow rate of the hydraulic pump coupled to such an electric motor is still proportional to the speed of the electrical motor.

The systems and methods described herein are directed to addressing one or more of the drawbacks set forth above.

### SUMMARY

According to a first aspect, an on-demand electric motor controlled hydraulic system may include a hydraulic pump, an electric motor coupled to the hydraulic pump, and an electronic control module (ECM) coupled to the hydraulic pump and the electric motor, is provided. The hydraulic pump has a swashplate with a swashplate angle adjustable to adjust a flow rate of the hydraulic pump and the electric motor is operable at a motor rate to drive the hydraulic pump. The ECM is configured to receive a demand for operating the hydraulic pump, determine a flow demand of the hydraulic pump associated with the demand, set the swashplate angle of a swashplate of the hydraulic pump to an initial swashplate angle, the initial swashplate angle setting a flow rate of the hydraulic pump corresponding to the flow demand, and operate the electric motor at a motor rate, the motor rate corresponding to the flow demand.

According to another aspect, a method performed by an ECM may include receiving a demand for operating a hydraulic pump, determining a flow demand of the hydraulic pump associated with the demand, setting a swashplate angle of a swashplate of the hydraulic pump to an initial swashplate angle, the initial swashplate angle setting a flow rate of the hydraulic pump corresponding to the flow demand, and operating an electric motor coupled to the hydraulic pump at a motor rate, the motor rate corresponding to the flow demand.

According to yet another aspect, a machine may include a frame and an on-demand electric motor controlled hydraulic system supported by the frame. The on-demand electric motor controlled hydraulic system may include a hydraulic pump, an electric motor coupled to the hydraulic pump, and an ECM coupled to the hydraulic pump and the electric motor, is provided. The hydraulic pump has a swashplate with a swashplate angle adjustable to adjust a flow rate of the hydraulic pump and the electric motor is operable at a motor rate to drive the hydraulic pump. The ECM is configured to receive a demand for operating the hydraulic pump, determine a flow demand of the hydraulic pump associated with the demand, set the swashplate angle of a swashplate of the hydraulic pump to an initial swashplate angle, the initial swashplate angle setting a flow rate of the hydraulic pump corresponding to the flow demand, and operate the electric motor at a motor rate, the motor rate corresponding to the flow demand.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 illustrates a schematic side view of an example machine with an on-demand electric motor controlled hydraulic system.

FIG. 2 illustrates a schematic view of the on-demand electric motor controlled hydraulic system shown with associated components.

FIG. 3 provides a flow chart representing an example operational process of the on-demand electric motor controlled hydraulic system.

FIG. 4 provides a flow chart representing an example operational process of one of the blocks of FIG. 3.

### DETAILED DESCRIPTION

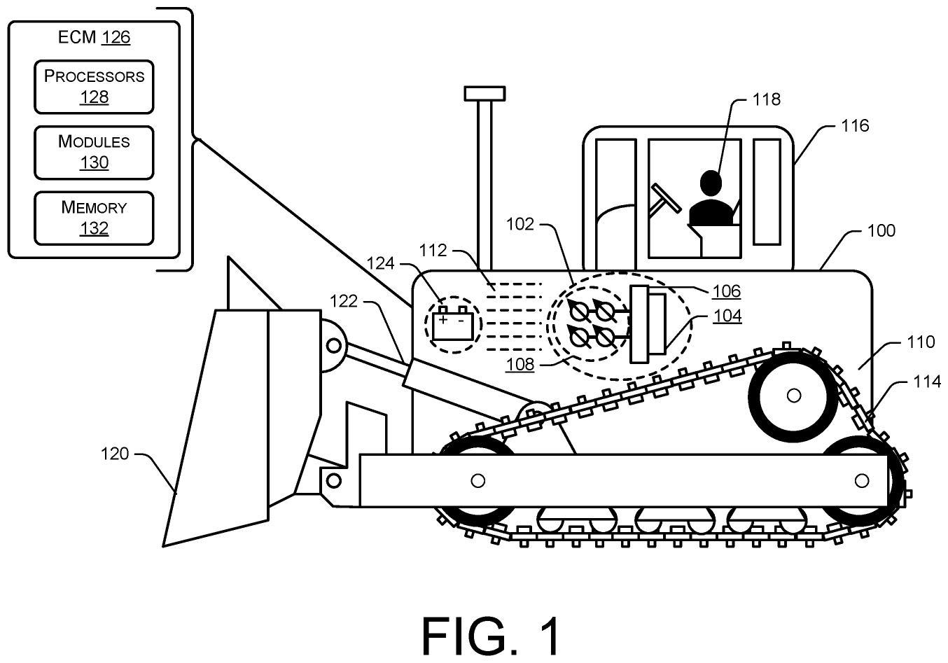

FIG. 1 is a schematic side view of an example machine 100 with an on-demand electric motor controlled hydraulic system 102 which includes an electric motor 104, a pump drive 106 coupled to the electric motor 104, and one or more hydraulic pumps 108 driven by the electric motor 104 via the pump drive 106. The pump drive 106 may include a gearing mechanism to step up or down the rotating speed of the electric motor 104 for driving the one or more hydraulic pumps 108. A gearing ratio may be selected to match each hydraulic pump 108 for speed and torque required. The example machine 100 shown in FIG. 1 is a bulldozer. However, the machine 100 may be any type of work machine configured to travel across and perform operations on terrain, such as an agricultural vehicle, and work vehicles, such as a wheel loader, a track loader, a skid-steer loader, a grader, an on-highway truck, an off-highway truck, and/or any other machine known to a person skilled in the art.

The machine 100 includes a chassis or frame 110 to which a prime mover 112 is attached. The prime mover 112 may include an internal combustion engine or “engine”, a fuel cell, one or more batteries, or other prime mover types. The prime mover 112 is configured to supply power for operation of the machine 100, including, for example, operating work implements, electronics, and steering, and/or for supplying torque to drive members to propel the machine 100 across the terrain. For example, the machine 100 shown in FIG. 1 includes a pair of tracks 114 (only one set of tracks shown) that are configured to propel the machine 100 across pavement, gravel, dirt, or other work surfaces. Although the machine 100 includes tracks 114, it is contemplated that the machine 100 may include one or more wheels instead of, or in addition to, the tracks. The machine 100 also includes a cab 116 operationally connected to the frame 110 for protecting and/or providing comfort for an operator 118 of the machine 100, and/or for protecting control-related devices of the machine 100. In some examples, the machine 100 may be semi-autonomous or fully autonomous, and able to operate without an onboard or remote operator, and may not include the cab 116. In examples where the machine 100 is semi-autonomous or fully-autonomous, the machine 100 is prevented from, or avoids, accidentally colliding with or maneuvering undesirably close to other machines, personnel, and/or objects.

In the example shown in FIG. 1, the machine 100 also includes a work implement 120 for performing operations associated with the machine 100, such as digging, carrying, raising, and/or depositing material. Although the work implement 120 in FIG. 1 is illustrated as a shovel, other forms of work implements are contemplated. For example, the work implement 120 may include augers, brushcutters, brooms, grapples, hammers, pulverizers, rippers, rotors, shovels, and so forth. The machine 100 includes a work implement actuator 122 coupled at one end to the frame 110 and/or to the proximal end of the work implement 120. The work implement actuator 122 may be electric motors, hydraulic cylinders, or pneumatic cylinders. The work implement actuator 122 is configured to extend and retract, thereby pivoting the work implement 120 between an upright orientation and an at least partially inverted orientation, for example. In the upright orientation, the work implement 120 may hold material and in the at least partially inverted orientation, the work implement 120 may deposit or dump the material.

The machine 100 may include a battery 124 to power various electrical equipment in the machine 100 including the electric motor 104 and an electronic control module (ECM) 126. The ECM 126 houses one or more processors 128, which may execute any modules, components, or systems associated with the machine 100, some of which may be housed in the ECM 126 as shown as modules 130. In some examples, the processors 128 may include a central processing unit (CPU), a graphics processing unit (GPU), both CPU and GPU, or other processing units or components known in the art. Additionally, each of the processors 128 may possess its own local memory, which also may store program modules, program data, and/or one or more operating systems.

Computer-readable media, such as memory 132, associated with the machine 100 may include volatile memory (e.g., RAM), non-volatile memory (e.g., ROM, flash memory, miniature hard drive, memory card, or the like), or some combination thereof. The computer-readable media may be non-transitory computer-readable media. The computer-readable media may include or be associated with the one or more of the above-noted modules, which perform various operations associated with the machine 100. In some examples, one or more of the modules may include or be associated with computer-executable instructions that are stored by the computer-readable media and that are executable by one or more processors to perform such operations.

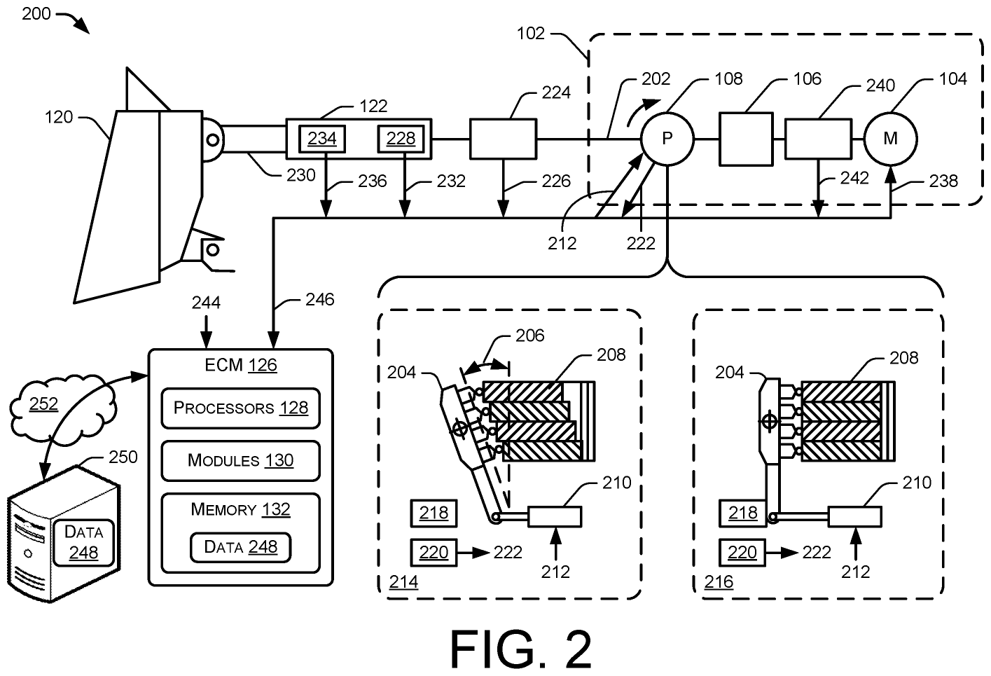

As discussed above, the conventional practice of continuously turning the hydraulic pumps creates parasitic loads on the engine and decreases energy efficiency of the machine. As will be described in greater detail below, FIG. 2 provides a schematic view 200 of the on-demand electric motor controlled hydraulic system 102 shown with the electric motor 104, which drives the hydraulic pump 108 (one hydraulic pump shown) via the pump drive 106, and the load actuator 122, and associated components. An output 202 of the hydraulic pump 108 is coupled to a load actuator, such as the work implement actuator 122, to operate a device, such as the work implement 120, which may be augers, brushcutters, brooms, grapples, hammers, pulverizers, rippers, rotors, shovels, and so forth. For simplicity, check valves, regulators, return hydraulic lines, hydraulic fluid reservoirs, and other components normally associated with a hydraulic system are omitted from this illustration.

The hydraulic pump 108 includes a swashplate 204, which may be adjusted by a swashplate angle 206 to vary a flow rate, or a pump displacement, of the hydraulic pump 108 by setting a plurality of pistons 208. The swashplate angle 206 is adjected by a compensator piston 210, which is a solenoid controlled by a compensator drive signal 212 from the ECM 126. A simplified cutaway view 214 of the hydraulic pump 108 illustrates the hydraulic pump 108 with the swashplate angle 206 set for a full flow, and a simplified cutaway view 216 of the hydraulic pump 108 illustrates the hydraulic pump 108 with the swashplate angle 206 set for no flow. The hydraulic pump 108 may additionally include a mechanical limiter 218, which prevents the compensator piston 210 from overdriving the swashplate 204, and an angle sensor 220, which monitors the swashplate angle 206 and provides swashplate angle information 222 to the ECM 126.

Hydraulic fluid pressure at the hydraulic fluid output 202 is applied to the work implement actuator 122 and monitored by a hydraulic pressure sensor 224, which provides output pressure information 226 associated with the monitored hydraulic fluid pressure to the ECM 126. The work implement actuator 122 may include a position sensor 228 that monitors the position of an actuator piston 230 and provide position information 232 associated with the actuator piston position to the ECM 126. The work implement actuator 122 may additionally include an actuator pressure sensor 234 that monitors the hydraulic fluid pressure in the work implement actuator 122 and provide actuator pressure information 236 associated with the hydraulic fluid pressure in the work implement actuator 122 to the ECM 126. The ECM 126 controls the electric motor 104 that turns the hydraulic pump 108 to generate hydraulic pressure by a motor control signal 238. The speed of the electric motor 104 may be monitored by a motor speed sensor 240, which provides motor speed information 242 associated with the motor speed to the ECM 126.

The operation of the on-demand electric motor controlled hydraulic system 102 may begin in response to the ECM 126 receiving a request 244 for operating the hydraulic pump 108. For example, the operator 118 of the machine 100 may initiate engaging the work implement 120, such as a shovel, to move some gravel by scooping the gravel. In response to receiving the request 244, the ECM 126 may activate the on-demand electric motor controlled hydraulic system 102. To reduce a power consumption rate and increase, or optimize, the power consumption efficiency, the power to the on-demand electric motor controlled hydraulic system 102, and more specifically, power to the electric motor 104, for example, from the battery 124, is turned on only when there is a request to utilize the on-demand electric motor controlled hydraulic system 102. The power to the electric motor 104 is turned off once the ECM 126 stops receiving the request 244 and stops receiving a demand 246 for operating the on-demand electric motor controlled hydraulic system 102. In response to receiving the request 244, the ECM may begin receiving the demand 246 for operating the on-demand electric motor controlled hydraulic system 102 comprising a plurality of monitored information described above, such as the swashplate angle information 222, the output pressure information 226, the position information 232, the actuator pressure information 236, and the motor speed information 242. The power to the on-demand electric motor controlled hydraulic system 102 is turned off in response to stopping receiving the request 244 and the demand 246 by the ECM 126.

Based on some or all of information in the demand 246, the ECM 126 may determine a flow demand of the hydraulic pump 108 associated with the demand 246. For example, the shovel as the work implement 120 may be currently exerting some force against a pile of gravel. The actuator pressure sensor 234 monitors the pressure in the actuator 122 corresponding to the force and provides the actuator pressure information 236 to the ECM 126 in the demand 246. The ECM 126 may determine a flow demand of the hydraulic pump 108, in liters per minute, for example, required to balance against the force. The ECM 126 may set the swashplate angle 206 of the swashplate 204 of the hydraulic pump 108 to an initial swashplate angle, which sets a flow rate, or a displacement, of the hydraulic pump 108, in liters/revolution for example, corresponding to the flow demand. The ECM 126 may set the swashplate angle 206 by sending the compensator drive signal 212 to the compensator piston 210 to set the swashplate angle 206 to a desired angle, such as the initial swashplate angle, and verify the swashplate angle 206 by the angle sensor 220. The ECM may adjust the compensator drive signal 212 based on the swashplate angle information 222 from the angle sensor 220. The ECM 126 may then operate the electric motor 104 at a motor rate that corresponds to the flow demand.

The ECM 126 may determine, or select, the initial swashplate angle based on performance efficiency data 248 for optimized efficiency of the on-demand electric motor controlled hydraulic system 102 for the flow demand. The performance efficiency data 248 may be stored in the memory 132 of the ECM 126, and/or in a cloud database, or a back office server, 250, which the ECM 126 can access via a wired or wireless communication network 252, such as the Internet, a cellular network, local area network (LAN), wireless LAN (WLAN), and the like. The performance efficiency data 248 may include a swashplate angle and a motor rate combination for a flow demand for optimized power consumption efficiency of the electric motor 104. For example, given a flow demand, the performance efficiency data 248 provides a swashplate angle and a motor rate combination, for which the electric motor 104 requires the least electric power, i.e., the most efficient for the on-demand electric motor controlled hydraulic system 102. The motor rate corresponding to the flow demand may include a motor speed, in revolutions per minute (RPM), for example, of the electric motor 104 corresponding to the flow demand, and a motor power modulation, such as a pulse width modulation (PWM) and a duty cycle, corresponding to the flow demand. The performance efficiency data 248 may include at least one of historical swashplate angle data of the on-demand electric motor controlled hydraulic system 102 or historical swashplate angle data of a plurality of hydraulic systems similar to the on-demand electric motor controlled hydraulic system 102 (“similar” meaning the plurality of hydraulic systems has one or more parameters such as dimensions, construction and/or modes of operations which are sufficiently comparable so that one or more aspects of the performance of one such hydraulic system can be used to extrapolate the corresponding performance of another such hydraulic system). For example, a fleet of machines having similar hydraulic systems may share the performance efficiency data 248, and benefit from data collected by other machines. Similarly, the ECM 126 may determine, or select, the motor rate corresponding to the flow demand based on the performance efficiency data 248. The performance efficiency data 248 may additionally comprises at least one of historical motor rate data of the on-demand electric motor controlled hydraulic system 102, or historical motor rate data of the plurality of hydraulic systems similar to the on-demand electric motor controlled hydraulic system 102.

The ECM 126 and/or the cloud server 250 may be configured to implement pattern/sequence recognition into a real-time decision loop that, e.g., is enabled by machine learning. The types of machine learning implemented by the ECM 126 and/or the cloud server 250 may include various approaches to learning and pattern recognition. The machine learning may include the implementation of associative memory, which allows storage, discovery, and retrieval of learned associations between extremely large numbers of attributes in real time. At a basic level, an associative memory stores information about how attributes and their respective features occur together. The predictive power of the associative memory technology comes from its ability to interpret and analyze these co-occurrences and to produce various metrics. Associative memory is built through “experiential” learning in which each newly observed state is accumulated in the associative memory as a basis for interpreting future events. Thus, by observing normal system operation over time, and the normal predicted system operation over time, the associative memory is able to learn normal patterns as a basis for identifying non-normal behavior and appropriate responses, and to associate patterns with particular outcomes, contexts or responses.

The ECM 126 and/or the cloud server 250 may utilize a machine learning engine that includes a receiving module configured to receive training data from the plurality of monitored information described above, such as the swashplate angle information 222, the output pressure information 226, the position information 232, the actuator pressure information 236, and the motor speed information 242. The training data may include real-time configuration and operational data, and may be communicated to the receiving module and to the machine learning engine over wireless and/or wired networks 252. The training data may be relevant to optimize power consumption efficiency of the on-demand electric motor controlled hydraulic system 102, including a plurality of first input conditions and a plurality of first responses associated with the first input conditions. The training data may include historical operational data acquired by the receiving module such as the plurality of monitored information via various sensors associated with the machine 100. The training data may also include data from a plurality of machines similar to the machine 100 and/or from a plurality of machines equipped with hydraulic systems similar to the on-demand electric motor controlled hydraulic system 102. The first input conditions, such as varying the swashplate angle 206, can represent conditions which, when applied to the on-demand electric motor controlled hydraulic system 102, lead to a particular response being performed, such as the motor rate adjusted to meet the flow demand.

The machine learning engine may be configured to train a learning system using the training data to generate a second response based on a second input condition. The machine learning engine can provide the training data as an input to the learning system, monitor an output of the learning system, and modify the learning system based on the output. The machine learning engine can compare the output to the plurality of first responses, determine a difference between the output and the plurality of first responses, and modify the learning system based on the difference between the output and the plurality of first responses. For example, the machine learning engine can be configured to modify characteristics of the learning system to optimize the power consumption efficiency of the on-demand electric motor controlled hydraulic system 102. The machine learning engine can group the training data into a first set of training data for executing a first learning protocol, and a second set of training data for executing a second learning protocol.

The learning system can include a learning function configured to associate the plurality of input conditions to the plurality of first responses, and the learning function can define characteristics, such as a plurality of parameters. The machine learning engine can be configured to modify the plurality of parameters to decrease the difference between the output of the learning system (e.g., the output of the learning function) and the plurality of first responses. Once trained, the learning system can be configured to receive the second input condition and apply the learning function to the second input condition to generate the second response. In some embodiments, the learning system may include a neural network. The neural network can include a plurality of layers each including one or more nodes, such as a first layer (e.g., an input layer), a second layer (e.g., an output layer), and one or more hidden layers. The neural network can include characteristics such weights and biases associated with computations that can be performed between nodes of layers. The machine learning engine can be configured to train the neural network by providing the first input conditions to the first layer of the neural network. The neural network can generate a plurality of first outputs based on the first input conditions, such as by executing computations between nodes of the layers. The machine learning engine can receive the plurality of first outputs, and modify a characteristic of the neural network to reduce a difference between the plurality of first outputs and the plurality of first responses.

In some embodiments, the learning system may include a classification engine, such as a support vector machine (SVM). The SVM can be configured to generate a mapping of first input conditions to first responses. For example, the machine learning engine may be configured to train the SVM to generate one or more rules configured to classify training pairs (e.g., each first input condition and its corresponding first response). The classification of training pairs can enable the mapping of first input conditions to first responses by classifying a particular first response as corresponding to particular first input conditions. Once trained, the learning system can generate the second response based on the second input condition by applying the mapping or classification to the second input condition.

In some embodiments, the learning system may include a Markov decision process engine. The machine learning engine may be configured to train the Markov decision process engine to determine a policy based on the training data, the policy indicating, representing, or resembling how a particular electric motor controlled hydraulic system would behave while controlled by an experienced human operator in response to various input conditions. The machine learning engine can provide the first input conditions to the Markov decision process engine as a set or plurality of states (e.g., a set or plurality of finite states). The machine learning engine can provide the first responses to the Markov decision process as a set or plurality of actions (e.g., a set or plurality of finite actions). The machine learning engine can execute the Markov decision process engine to determine the policy that best represents the relationship between the first input conditions and first responses. It will be appreciated that in various embodiments, the learning system can include various other machine learning engines and algorithms, as well as combinations of machine learning engines and algorithms, that can be executed to determine a relationship between the plurality of first input conditions and the plurality of first responses and thus train the learning system.

For example, the ECM 126, utilizing the machine learning engine, may optimize, or improve, the power consumption efficiency of the on-demand electric motor controlled hydraulic system 102. The ECM 126 may first determine an initial power consumption rate of the electric motor 104 based on the motor rate and the flow rate as the on-demand electric motor controlled hydraulic system 102 is activated as an initial condition. For example, the ECM 126 may monitor and utilize the voltage and the current for the electric motor 104, to meet the flow rate of the hydraulic pump 108 required to balance a load on the on-demand electric motor controlled hydraulic system 102, for determining the power consumption rate, such as the initial power consumption rate. The torque output and the motor rate of the electric motor 104 to meet the flow rate of the hydraulic pump 108 required, may also be utilized to determine the power consumption rate. Additionally, the torque output and the rotational (angular) velocity of the hydraulic pump 108, may also be utilized to determine the power consumption rate. Further, any combination of the power consumption calculation/determination described above may be utilized. To attempt to improve the power consumption efficiency of the on-demand electric motor controlled hydraulic system 102, the ECM 126 may obtain a first adjusted swashplate angle by adjusting the swashplate angle 206 in one direction. For example, the swashplate angle 206 may be adjusted to be wider than the initial swashplate angle by a first predetermined amount to produce a first adjusted flow rate. The ECM 126 may obtain a first adjusted motor rate by adjusting the motor rate of the electric motor 104 that meets the flow demand at the first adjusted flow rate. Based on the first adjusted flow rate and the first adjusted motor rate, the ECM 126 may determine a first power consumption rate, and determine whether the first power consumption rate is lower than the initial power consumption rate. In response to determining that the first power consumption rate is lower than the initial power consumption rate, i.e., an improvement in the power consumption efficiency, the ECM 126 may store the first adjusted swashplate angle as the swashplate angle for the flow demand in the performance efficiency data 248 and store the first adjusted motor rate as the motor rate for the flow demand in the performance efficiency data 248.

In response to determining that the first power consumption rate is not lower than the initial power consumption rate, the ECM 126 may then obtain a second adjusted swashplate angle by adjusting the swashplate angle 206 in an opposite direction to the one direction, narrower than the initial swashplate angle for example, by a second predetermined amount to produce a second adjusted flow rate, and obtain a second adjusted motor rate by adjusting the motor rate of the electric motor 104 that meets the flow demand at the second adjusted flow rate. Based on the second adjusted flow rate and the second adjusted motor rate, the ECM 126 may determine a second power consumption rate, and determine whether the second power consumption rate is lower than the initial power consumption rate. In response to determining that the second power consumption rate is lower than the initial power consumption rate, i.e., an improvement in the power consumption efficiency, the ECM 126 store the second adjusted swashplate angle as the swashplate angle for the flow demand in the performance efficiency data 248 and store the second adjusted motor rate as the motor rate for the flow demand in the performance efficiency data 248. Additionally, as the load on the on-demand electric motor controlled hydraulic system 102 changes, the ECM 126 may re-calculate the initial power consumption rate based on the new load as the initial condition, and may repeat the process of adjusting the swashplate angle and evaluating efficiency of the on-demand electric motor controlled hydraulic system 102 as described above.

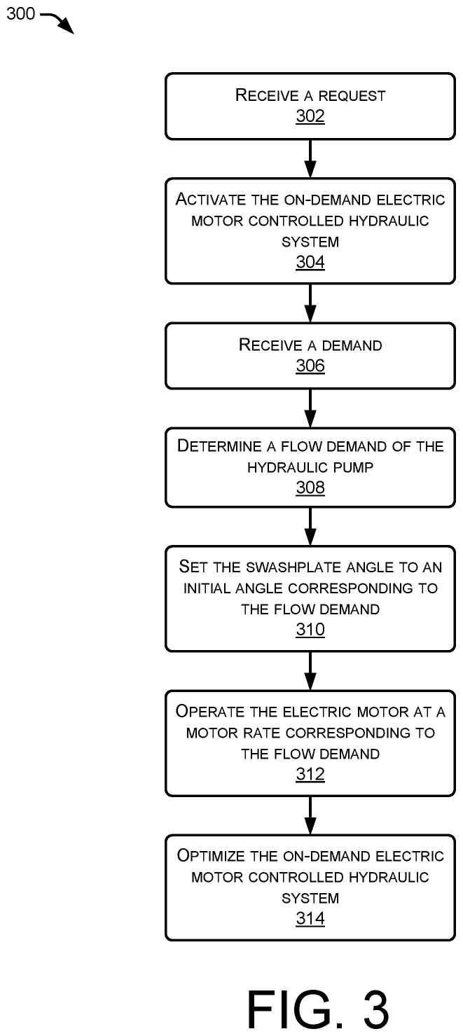

FIG. 3 provides a flow chart 300 representing an example operational process of the on-demand electric motor controlled hydraulic system 102. The process of the flow chart 300 is illustrated as a logical flow graph, operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the process.

The operation of the on-demand electric motor controlled hydraulic system 102 may begin in response to the ECM 126 receiving a request 244 for operating the hydraulic pump 108 at block 302 as described above with reference to FIG. 2. In response to receiving the request 244, the ECM 126 may activate the on-demand electric motor controlled hydraulic system 102 at block 304. To reduce the power consumption rate and increase, or optimize, the power consumption efficiency, the power to the on-demand electric motor controlled hydraulic system 102, and more specifically, power to the electric motor 104, is turned on only when there is a request to utilize the on-demand electric motor controlled hydraulic system 102, and is turned off once the ECM 126 stops receiving the request. The ECM 126 may then begin receiving a demand 246 for operating the on-demand electric motor controlled hydraulic system 102 at block 306. The demand 246 may comprise a plurality of monitored information described above, such as the swashplate angle information 222, the output pressure information 226, the position information 232, the actuator pressure information 236, and the motor speed information 242. The power to the on-demand electric motor controlled hydraulic system 102 is turned off in response to stopping receiving the request 244 by the ECM 126, and ECM 126 stops receiving the demand 246 as described above with reference to FIG. 2.

Based on some or all of information in the demand 246, the ECM 126 may determine a flow demand of the hydraulic pump 108 associated with the demand 246 at block 308. For example, the shovel, as the work implement 120, may be currently exerting some force against a pile of gravel. The actuator pressure sensor 234 monitors the pressure in the actuator 122 that corresponds to the force, and provides the actuator pressure information 236 to the ECM 126 in the demand 246. The ECM 126 may determine the flow demand of the hydraulic pump 108, in liters per minute, for example, required to balance against the force. At block 310, the ECM 126 may set the swashplate angle 206 of the swashplate 204 of the hydraulic pump 108 to an initial swashplate angle, which sets a flow rate, or a displacement, of the hydraulic pump 108, in liters/revolution for example, corresponding to the flow demand. As described above with reference to FIG. 2, the ECM 126 may set the swashplate angle 206 by sending the compensator drive signal 212 to the compensator piston 210 to set the swashplate angle 206 to a desired angle, such as the initial swashplate angle, and verify the swashplate angle 206 by the angle sensor 220. The ECM may adjust the compensator drive signal 212 based on the swashplate angle information 222 from the angle sensor 220. The ECM 126 may then operate the electric motor 104 at a motor rate that corresponds to the flow demand at block 312.

The ECM 126 may determine, or select, the initial swashplate angle based on performance efficiency data 248 for optimized efficiency of the on-demand electric motor controlled hydraulic system 102 for the flow demand. The performance efficiency data 248 may be stored in the memory 132 of the ECM 126, and/or in a cloud database, or a back office server, 250, which the ECM 126 can access via a wired or wireless communication network 252, such as the Internet, a cellular network, local area network (LAN), wireless LAN (WLAN), and the like. The performance efficiency data 248 may include a swashplate angle and a motor rate combination for a flow demand for optimized power consumption efficiency of the electric motor 104. For example, given a flow demand, the performance efficiency data 248 provides a swashplate angle and a motor rate combination, for which the electric motor 104 requires the least electric power, i.e., the most efficient for the on-demand electric motor controlled hydraulic system 102. The motor rate corresponding to the given flow demand may include a motor speed, in revolution per minute (RPM), for example, of the electric motor 104 corresponding to the flow demand, and a motor power modulation, such as a pulse width modulation (PWM) and a duty cycle, corresponding to the flow demand. The performance efficiency data 248 may include at least one of historical swashplate angle data of the on-demand electric motor controlled hydraulic system 102 or historical swashplate angle data of a plurality of hydraulic systems similar to the on-demand electric motor controlled hydraulic system 102. Similarly, the ECM 126 may determine, or select, the motor rate corresponding to the flow demand based on the performance efficiency data 248. The performance efficiency data 248 may additionally include at least one of historical motor rate data of the on-demand electric motor controlled hydraulic system 102, or historical motor rate data of the plurality of hydraulic systems similar to the on-demand electric motor controlled hydraulic system 102. At block 314, the ECM 126 may adjust the swashplate angle 206 and/or the motor rate to further reduce the power consumption rate and increase, or optimize, the power consumption efficiency, of the on-demand electric motor controlled hydraulic system 102.

The ECM 126 and/or the cloud server 250 may be configured to implement pattern/sequence recognition into a real-time decision loop that, e.g., is enabled by machine learning. The types of machine learning implemented by the ECM 126 and/or the cloud server 250 may include various approaches to learning and pattern recognition. The machine learning may include the implementation of associative memory, which allows storage, discovery, and retrieval of learned associations between extremely large numbers of attributes in real time. At a basic level, an associative memory stores information about how attributes and their respective features occur together. The predictive power of the associative memory technology comes from its ability to interpret and analyze these co-occurrences and to produce various metrics. Associative memory is built through “experiential” learning in which each newly observed state is accumulated in the associative memory as a basis for interpreting future events. Thus, by observing normal system operation over time, and the normal predicted system operation over time, the associative memory is able to learn normal patterns as a basis for identifying non-normal behavior and appropriate responses, and to associate patterns with particular outcomes, contexts or responses.

The ECM 126 and/or the cloud server 250 may utilize a machine learning engine that includes a receiving module configured to receive training data from the plurality of monitored information described above, such as the swashplate angle information 222, the output pressure information 226, the position information 232, the actuator pressure information 236, and the motor speed information 242. The training data may include real-time configuration and operational data, and may be communicated to the receiving module and to the machine learning engine over wireless and/or wired networks 252. The training data may be relevant to optimize power consumption efficiency of the on-demand electric motor controlled hydraulic system 102, including a plurality of first input conditions and a plurality of first responses associated with the first input conditions. The training data may include historical operational data acquired by the receiving module such as the plurality of monitored information via various sensors associated with the machine 100. The training data may also include data from a plurality of machines similar to the machine 100 and/or from a plurality of machines equipped with on-demand electric motor controlled hydraulic systems similar to the on-demand electric motor controlled hydraulic system 102. The first input conditions, such as varying the swashplate angle 206, can represent conditions which, when applied to the on-demand electric motor controlled hydraulic system 102, lead to a particular response being performed, such as the motor rate adjusted to meet the flow demand.

The machine learning engine may be configured to train a learning system using the training data to generate a second response based on a second input condition. The machine learning engine can provide the training data as an input to the learning system, monitor an output of the learning system, and modify the learning system based on the output. The machine learning engine can compare the output to the plurality of first responses, determine a difference between the output and the plurality of first responses, and modify the learning system based on the difference between the output and the plurality of first responses. For example, the machine learning engine can be configured to modify characteristics of the learning system to optimize the power consumption efficiency of the on-demand electric motor controlled hydraulic system 102. The machine learning engine can group the training data into a first set of training data for executing a first learning protocol, and a second set of training data for executing a second learning protocol.

The learning system can include a learning function configured to associate the plurality of input conditions to the plurality of first responses, and the learning function can define characteristics, such as a plurality of parameters. The machine learning engine can be configured to modify the plurality of parameters to decrease the difference between the output of the learning system (e.g., the output of the learning function) and the plurality of first responses. Once trained, the learning system can be configured to receive the second input condition and apply the learning function to the second input condition to generate the second response. In some embodiments, the learning system may include a neural network. The neural network can include a plurality of layers each including one or more nodes, such as a first layer (e.g., an input layer), a second layer (e.g., an output layer), and one or more hidden layers. The neural network can include characteristics such weights and biases associated with computations that can be performed between nodes of layers. The machine learning engine can be configured to train the neural network by providing the first input conditions to the first layer of the neural network. The neural network can generate a plurality of first outputs based on the first input conditions, such as by executing computations between nodes of the layers. The machine learning engine can receive the plurality of first outputs, and modify a characteristic of the neural network to reduce a difference between the plurality of first outputs and the plurality of first responses.

In some embodiments, the learning system may include a classification engine, such as a support vector machine (SVM). The SVM can be configured to generate a mapping of first input conditions to first responses. For example, the machine learning engine may be configured to train the SVM to generate one or more rules configured to classify training pairs (e.g., each first input condition and its corresponding first response). The classification of training pairs can enable the mapping of first input conditions to first response by classifying particular first response as corresponding to particular first input conditions. Once trained, the learning system can generate the second response based on the second input condition by applying the mapping or classification to the second input condition.

In some embodiments, the learning system may include a Markov decision process engine. The machine learning engine may be configured to train the Markov decision process engine to determine a policy based on the training data, the policy indicating, representing, or resembling how a particular electric motor controlled hydraulic system would behave while controlled by an experienced human operator in response to various input conditions. The machine learning engine can provide the first input conditions to the Markov decision process engine as a set or plurality of states (e.g., a set or plurality of finite states). The machine learning engine can provide the first responses to the Markov decision process as a set or plurality of actions (e.g., a set or plurality of finite actions). The machine learning engine can execute the Markov decision process engine to determine the policy that best represents the relationship between the first input conditions and first responses. It will be appreciated that in various embodiments, the learning system can include various other machine learning engines and algorithms, as well as combinations of machine learning engines and algorithms, that can be executed to determine a relationship between the plurality of first input conditions and the plurality of first responses and thus train the learning system.

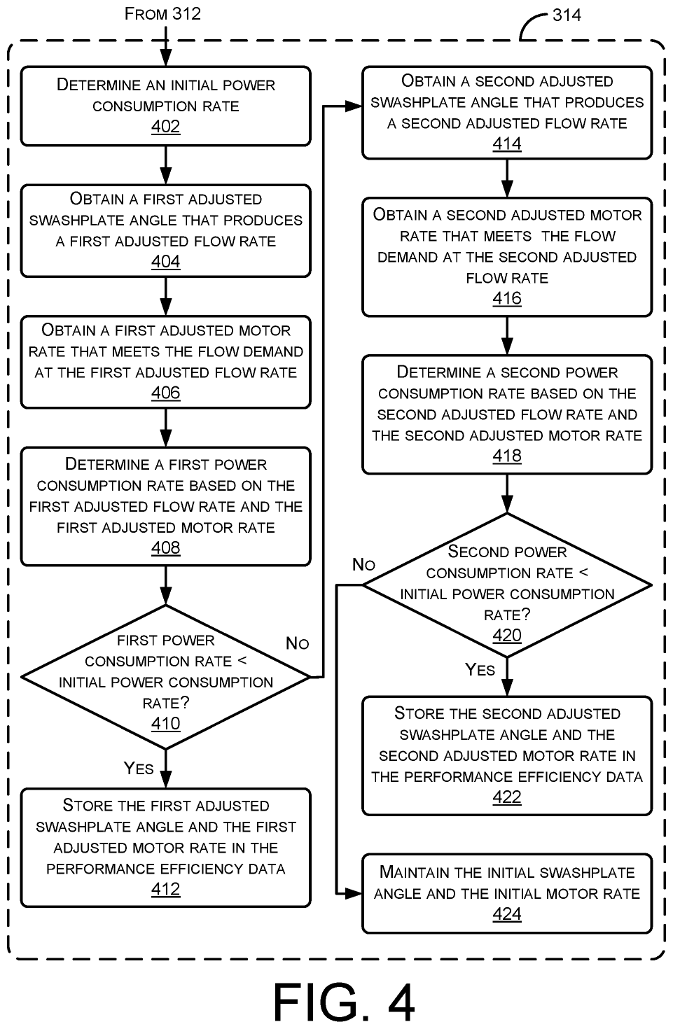

FIG. 4 provides a flow chart representing an example operational process of block 314 of FIG. 3. In this example, the ECM 126, utilizing the machine learning engine, may optimize, or improve, the power consumption efficiency of the on-demand electric motor controlled hydraulic system 102. At block 402, the ECM 126 may first determine an initial power consumption rate of the electric motor 104 based on the motor rate and the flow rate as the on-demand electric motor controlled hydraulic system 102 is activated as an initial condition. For example, the ECM 126 may monitor and utilize the voltage and the current for the electric motor 104, to meet the flow rate of the hydraulic pump 108 required to balance a load on the on-demand electric motor controlled hydraulic system 102, for determining the power consumption rate, such as the initial power consumption rate. The torque output and the motor rate of the electric motor 104 to meet the flow rate of the hydraulic pump 108 required, may also be utilized to determine the power consumption rate. Additionally, the torque output and the rotational (angular) velocity of the hydraulic pump 108, may also be utilized to determine the power consumption rate. Further, any combination of the power consumption calculation/determination described above may be utilized. To attempt to improve the power consumption efficiency of the on-demand electric motor controlled hydraulic system 102, the ECM 126 may obtain a first adjusted swashplate angle by adjusting the swashplate angle 206 in one direction at block 404. For example, the swashplate angle 206 may be adjusted to be wider than the initial swashplate angle by a first predetermined amount to produce a first adjusted flow rate. The ECM 126 may obtain a first adjusted motor rate by adjusting the motor rate of the electric motor 104 that meets the flow demand at the first adjusted flow rate at block 406. Based on the first adjusted flow rate and the first adjusted motor rate, the ECM 126 may determine a first power consumption rate at block 408. At block 410, the ECM may determine whether the first power consumption rate is lower than the initial power consumption rate. In response to determining that the first power consumption rate is lower than the initial power consumption rate at block 410, i.e., an improvement in the power consumption efficiency, the ECM 126 may store the first adjusted swashplate angle as the swashplate angle for the flow demand and the first adjusted motor rate as the motor rate for the flow demand in the performance efficiency data 248 at block 412.

In response to determining that the first power consumption rate is not lower than the initial power consumption rate at block 410, the ECM 126 may obtain a second adjusted swashplate angle at block 414 by adjusting the swashplate angle 206 in an opposite direction to the one direction. For example, the swashplate angle 206 may be adjusted to be narrower than the initial swashplate angle by a second predetermined amount to produce a second adjusted flow rate. The ECM 126 may obtain a second adjusted motor rate by adjusting the motor rate of the electric motor 104 that meets the flow demand at the second adjusted flow rate at block 416. Based on the second adjusted flow rate and the second adjusted motor rate, the ECM 126 may determine a second power consumption rate at block 418. At block 420, the ECM 126 may determine whether the second power consumption rate is lower than the initial power consumption rate. In response to determining that the second power consumption rate is lower than the initial power consumption rate at block 420, i.e., an improvement in the power consumption efficiency, the ECM 126 store the second adjusted swashplate angle as the swashplate angle for the flow demand and the second adjusted motor rate as the motor rate for the flow demand in the performance efficiency data 248 at block 422. In response to determining that the second power consumption rate is not lower than the initial power consumption rate at block 420, the ECM 126 may maintain the initial swashplate angle and the initial motor rate as the swashplate angle and the motor rate for the flow demand in the performance efficiency data 248 at block 424. Additionally, or alternatively, the process may loop back to block 404 with a third predetermined amount for adjusting the swashplate angle 206 in the one direction. Similarly, a fourth predetermined amount may be used at block 414 for adjusting the swashplate angle 206 in the opposite direction. This process may be continuously executed while the on-demand electric motor controlled hydraulic system 102 is active, and in response to the load on the on-demand electric motor controlled hydraulic system 102 changes, the ECM 126 may re-calculate the initial power consumption rate based on the new load as the initial condition, and may repeat the process from block 402. The machine learning may continue optimizing the power consumption efficiency of the on-demand electric motor controlled hydraulic system 102 while the on-demand electric motor controlled hydraulic system 102 is active.

### INDUSTRIAL APPLICABILITY

The example systems and methods of the present disclosure are applicable to a variety of machines, such as, for example, marine vehicles, an agricultural vehicle, a paving machine, a mining machine, and/or construction vehicles. The systems and methods described herein may be used in association with a hydraulically operated equipment of the machines. For example, to optimize the power consumption associated with a hydraulic system, a flow rate of a hydraulic pump and a motor rate of an electric motor driving the hydraulic pump may be continuously monitored and adjusted for an optimal power consumption.

For example, an on-demand electric motor controlled hydraulic system may include a hydraulic pump, an electric motor coupled to the hydraulic pump, and an electronic control module (ECM) coupled to the hydraulic pump and the electric motor. The hydraulic pump has a swashplate with a swashplate angle adjustable to adjust a flow rate of the hydraulic pump and the electric motor is operable at a motor rate to drive the hydraulic pump. The ECM is configured to receive a demand for operating the hydraulic pump, determine a flow demand of the hydraulic pump associated with the demand, set the swashplate angle of a swashplate of the hydraulic pump to an initial swashplate angle, the initial swashplate angle setting a flow rate of the hydraulic pump corresponding to the flow demand, and operate the electric motor at a motor rate, the motor rate corresponding to the flow demand.

The ECM and/or the cloud server may utilize a machine learning engine that includes a receiving module configured to receive training data from the plurality of monitored information, such as the swashplate angle information, the output pressure information, the position information, the actuator pressure information, and the motor speed information. The training data may include real-time configuration and operational data, and may be communicated to the receiving module and to the machine learning engine over wireless and/or wired networks. The training data may be relevant to optimize power consumption efficiency of the on-demand electric motor controlled hydraulic system, may include historical operational data acquired by the receiving module such as the plurality of monitored information via various sensors associated with the machine. The training data may also include data from a plurality of machines similar to the machine and/or from a plurality of machines equipped with hydraulic systems similar to the on-demand electric motor controlled hydraulic system. The first input conditions, such as varying the swashplate angle, can represent conditions which, when applied to the on-demand electric motor controlled hydraulic system, lead to a particular response being performed, such as the motor rate being adjusted to meet the flow demand. Resulting responses and associated conditions may be stored as performance efficiency data.

Additionally, by maintaining the performance efficiency data based on a plurality of machines having hydraulic system similar to the on-demand electric motor controlled hydraulic system and having the performance efficiency data accessible by a plurality of machines, a wider range of data can be more quickly collected, and a larger number of machines can benefit from utilizing the performance efficiency data.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the examples above, it will be understood by those skilled in the art that various additional embodiments may be contemplated by the modification of the disclosed devices, systems, and methods without departing from the spirit and scope of what is disclosed. Such embodiments should be understood to fall within the scope of the present disclosure as determined based upon the claims and any equivalents thereof.

What is claimed is:

1. An on-demand electric motor controlled hydraulic system comprising:
a hydraulic pump having a swashplate with a swashplate angle adjustable to adjust a flow rate of the hydraulic pump;
an electric motor coupled to the hydraulic pump, the electric motor operable at a motor rate to drive the hydraulic pump; and
an electronic control module (ECM) coupled to the hydraulic pump and the electric motor, the ECM configured to:
receive a demand for operating the hydraulic pump,
determine a flow demand of the hydraulic pump associated with the demand,
set the swashplate angle of the swashplate of the hydraulic pump to an initial swashplate angle, the initial swashplate angle setting the flow rate of the hydraulic pump corresponding to the flow demand, and
operate the electric motor at the motor rate, the motor rate corresponding to the flow demand.

2. The on-demand electric motor controlled hydraulic system of claim 1, wherein the motor rate corresponding to the flow demand includes:
a motor speed of the electric motor corresponding to the flow demand, and
a motor power modulation corresponding to the flow demand.

3. The on-demand electric motor controlled hydraulic system of claim 1, wherein the initial swashplate angle is based on performance efficiency data for optimized efficiency of the on-demand electric motor controlled hydraulic system for the flow demand, the performance efficiency data comprising at least one of:
historical swashplate angle data of the on-demand electric motor controlled hydraulic system, or
historical swashplate angle data of a plurality of hydraulic systems similar to the on-demand electric motor controlled hydraulic system.

4. The on-demand electric motor controlled hydraulic system of claim 3, wherein the motor rate corresponding to the flow demand is based on the performance efficiency data, the performance efficiency data further comprising at least one of:
historical motor rate data of the on-demand electric motor controlled hydraulic system, or
historical motor rate data of the plurality of hydraulic systems similar to the on-demand electric motor controlled hydraulic system.

5. The on-demand electric motor controlled hydraulic system of claim 4, wherein the performance efficiency data is stored in a cloud database, the cloud database accessible by the on-demand electric motor controlled hydraulic system and the plurality of hydraulic systems similar to the on-demand electric motor controlled hydraulic system.

6. The on-demand electric motor controlled hydraulic system of claim 4, wherein the ECM is further configured to:
determine an initial power consumption rate of the electric motor based on the motor rate and the flow rate corresponding to the flow demand;
obtain a first adjusted swashplate angle by adjusting the swashplate angle in one direction by a first predetermined amount to produce a first adjusted flow rate;
obtain a first adjusted motor rate by adjusting the motor rate that meets the flow demand at the first adjusted flow rate;
determine a first power consumption rate of the electric motor based on the first adjusted flow rate and the first adjusted motor rate;
determine whether the first power consumption rate is lower than the initial power consumption rate; and
in response to determining that the first power consumption rate is lower than the initial power consumption rate:
store the first adjusted swashplate angle as the swashplate angle for the flow demand in performance efficiency data, and
store the first adjusted motor rate as the motor rate for the flow demand in the performance efficiency data.

7. The on-demand electric motor controlled hydraulic system of claim 6, wherein the ECM is further configured to, in response to determining that the first power consumption rate is not lower than the initial power consumption rate:
obtain a second adjusted swashplate angle by adjusting the swashplate angle in an opposite direction to the one direction by a second predetermined amount to produce a second adjusted flow rate;
obtain a second adjusted motor rate by adjusting the motor rate that meets the flow demand at the second adjusted flow rate;
determine a second power consumption rate of the electric motor based on the second adjusted flow rate and the second adjusted motor rate;
determine whether the second power consumption rate is lower than the initial power consumption rate; and
in response to determining that the second power consumption rate is lower than the initial power consumption rate:
store the second adjusted swashplate angle as the swashplate angle for the flow demand in the performance efficiency data, and
store the second adjusted motor rate as the motor rate for the flow demand in the performance efficiency data.

8. The on-demand electric motor controlled hydraulic system of claim 7, wherein the ECM is configured to utilize machine learning to optimize efficiency of the on-demand electric motor controlled hydraulic system.

9. The on-demand electric motor controlled hydraulic system of claim 1, wherein the ECM is further configured to:
keep the electric motor inactive until the demand is received; and
deactivate the electric motor in response to the demand no longer being received.

10. A method performed by an electronic control module (ECM) of an on-demand electric motor controlled hydraulic system for controlling a hydraulic fluid flow in the on-demand electric motor controlled hydraulic system, the method comprising:
receiving a demand for operating a hydraulic pump;
determining a flow demand of the hydraulic pump associated with the demand;
setting a swashplate angle of a swashplate of the hydraulic pump to an initial swashplate angle, the initial swashplate angle setting a flow rate of the hydraulic pump corresponding to the flow demand; and
operating an electric motor coupled to the hydraulic pump at a motor rate, the motor rate corresponding to the flow demand.

11. The method of claim 10, wherein the motor rate corresponding to the flow demand includes:
a motor speed of the electric motor corresponding to the flow demand, and
a motor power modulation corresponding to the flow demand.

12. The method of claim 10, wherein the initial swashplate angle is based on performance efficiency data for optimized efficiency of the on-demand electric motor controlled hydraulic system for the flow demand, the performance efficiency data comprising at least one of:
historical swashplate angle data of the on-demand electric motor controlled hydraulic system, or
historical swashplate angle data of a plurality of hydraulic systems similar to the on-demand electric motor controlled hydraulic system.

13. The method of claim 12, wherein the motor rate corresponding to the flow demand is based on the performance efficiency data, the performance efficiency data further comprising at least one of:
historical motor rate data of the on-demand electric motor controlled hydraulic system, or
historical motor rate data of the plurality of hydraulic systems similar to the on-demand electric motor controlled hydraulic system.

14. The method of claim 13, wherein the performance efficiency data is stored in a cloud database, the cloud database accessible by the on-demand electric motor controlled hydraulic system and the plurality of hydraulic systems similar to the on-demand electric motor controlled hydraulic system.

15. The method of claim 10, further comprising:
determining an initial power consumption rate of the electric motor based on the motor rate and the flow rate;
obtaining a first adjusted swashplate angle by adjusting the swashplate angle in one direction by a first predetermined amount to produce a first adjusted flow rate;
obtaining a first adjusted motor rate by adjusting the motor rate that meets the flow demand at the first adjusted flow rate;
determining a first power consumption rate of the electric motor based on the first adjusted flow rate and the first adjusted motor rate;
determining whether the first power consumption rate is lower than the initial power consumption rate; and
in response to determining that the first power consumption rate is lower than the initial power consumption rate:
storing the first adjusted swashplate angle as the swashplate angle for the flow demand in performance efficiency data, and
storing the first adjusted motor rate as the motor rate for the flow demand in the performance efficiency data.

16. The method of claim 15, further comprising, in response to determining that the first power consumption rate is not lower than the initial power consumption rate:
obtaining a second adjusted swashplate angle by adjusting the swashplate angle in an opposite direction to the one direction by a second predetermined amount to produce a second adjusted flow rate;
obtaining a second adjusted motor rate by adjusting the motor rate that meets the flow demand at the second adjusted flow rate;
determining a second power consumption rate of the electric motor based on the second adjusted flow rate and the second adjusted motor rate;
determining whether the second power consumption rate is lower than the initial power consumption; and
in response to determining that the second power consumption rate is lower than the initial power consumption:
storing the second adjusted swashplate angle as the swashplate angle for the flow demand in the performance efficiency data, and
storing the second adjusted motor rate as the motor rate for the flow demand in the performance efficiency data.

17. The method of claim 16, wherein the ECM utilizes machine learning to optimize efficiency of the on-demand electric motor controlled hydraulic system.

18. The method of claim 10, further comprising:
keeping the electric motor inactive until the demand is received; and
deactivating the electric motor in response to the demand no longer being received.

19. A machine comprising:
a frame; and
an on-demand electric motor controlled hydraulic system comprising:
a hydraulic pump supported by the frame, the hydraulic pump having a swashplate with a swashplate angle adjustable to adjust a flow rate of the hydraulic pump;
an electric motor supported by the frame and coupled to the hydraulic pump, the electric motor operable at a motor rate to drive the hydraulic pump; and
an electronic control module (ECM) coupled to the hydraulic pump and the electric motor, the ECM configured to:
receive a demand for operating the hydraulic pump,
determine a flow demand of the hydraulic pump associated with the demand,
set the swashplate angle of the swashplate of the hydraulic pump to an initial swashplate angle, the initial swashplate angle setting the flow rate of the hydraulic pump corresponding to the flow demand, and
operate the electric motor at the motor rate, the motor rate corresponding to the flow demand.

20. The machine of claim 19,
wherein the initial swashplate angle and the motor rate corresponding to the flow demand are based on performance efficiency data for optimized efficiency of the on-demand electric motor controlled hydraulic system for the flow demand, the performance efficiency data comprising:
at least one of:
historical swashplate angle data of the on-demand electric motor controlled hydraulic system, or
historical swashplate angle data of a plurality of hydraulic systems similar to the on-demand electric motor controlled hydraulic system, and
at least one of:
historical motor rate data of the on-demand electric motor controlled hydraulic system, or
historical motor rate data of the plurality of hydraulic systems, and
wherein the performance efficiency data is stored in a cloud database, and the cloud database is accessible by the on-demand electric motor controlled hydraulic system and the plurality of hydraulic systems similar to the on-demand electric motor controlled hydraulic system.
